(19) United States
(12) Patent Application Publication
(10) Pub. No.: US 2026/0348470 A1
(43) Pub. Date: Nov. 5, 2026

(54) SEAL ASSEMBLY FOR A HOUSING

(71) Applicant: ElringKlinger AG, Dettingen (DE)

(72) Inventors: Daniele Martino, Dettingen (DE); Luca Greco, Dettingen (DE)

(73) Assignee: ElringKlinger AG, Dettingen (DE)

(21) Appl. No.: 19/551,778

(22) Filed: Feb. 27, 2026

(30) Foreign Application Priority Data
Mar. 4, 2025 (DE) 10 2025 108 201.4

(51) Int. Cl. F16J 15/02

(52) U.S. Cl. CPC F16J 15/022

(57) ABSTRACT

A seal assembly, which comprises two seal elements connected to one another via a shape adaptation element. In this case, the shape adaptation element comprises a shape adaptation section and two connecting sections for connecting the shape adaptation element to the two seal elements of the seal assembly. The shape adaptation section can be transformed from a production state to an installation state by stretching or bending.

### RELATED APPLICATION

This application claims the benefit of German application No. 10 2025 108 201.4 filed on Mar. 4, 2025, which is incorporated herein by reference in its entirety and for all purposes.

### FIELD OF DISCLOSURE

The present invention relates to a seal assembly for a housing and to a housing comprising the seal assembly.

### BACKGROUND

Electrochemical systems, such as battery systems or fuel cell systems, generally comprise a housing. The housing protects the electrochemical system from mechanical and/or thermal loads. In addition, the housing is intended to prevent unwanted escape of gaseous and/or liquid substance flows from the electrochemical system. Conversely, the ingress of contaminants into the electrochemical system is also to be prevented.

For this purpose, the housing usually has one or more seal assemblies. Such a seal assembly is usually arranged between two or more housing components. The housing components can be a housing cover and a housing bottom part, for example. The housing bottom part can be of trough-shaped configuration, for example.

The seal assembly can also be an adhesive bond or a weld. One disadvantage of using the adhesive bond or the weld is that nondestructive opening of the housing is generally no longer possible.

Reversible sealing of the housing is made possible, for example, by using circumferential elastomer seals. However, the deformability of said seals has the disadvantage that increased assembly effort is often required in positioning the elastomer seal. Admittedly, the assembly effort can be reduced by using a housing component with a circumferential groove in a sealing surface. However, this requires an additional work step since the groove has to be milled into a housing component.

Elastomer seals are usually produced by an injection molding method. While injection molding seal assemblies for housings of smaller dimensions is easily possible, housings of vehicle batteries have large dimensions, for example. Their size may be 2500 mm×1500 mm, for example. The injection molding method becomes uneconomical when using molds of such large dimensions since the costs for the molds are extremely high. Moreover, seals of such large dimensions tend to twist.

### SUMMARY OF THE INVENTION

It is therefore the underlying object of the present invention to provide a seal assembly which can be produced economically and, in particular, does not tend to twist.

This object is achieved by a seal assembly as claimed in the relevant independent claim.

In the context of this description and of the appended claims, the term “in particular” is used to describe possible discretionary and/or optional features.

In particular, the seal assembly can be a seal assembly for a housing for an electrochemical system. In particular, the electrochemical system can be a battery system or a fuel cell system.

According to the invention, the seal assembly comprises two seal elements, which are connected to one another via a shape adaptation element. The shape adaptation element comprises a shape adaptation section and two connecting sections for connecting the shape adaptation element to the two seal elements of the seal assembly.

The shape adaptation section can be transformed from a production state to an installation state by stretching, in particular reversible stretching, or bending, in particular reversible bending.

The connecting sections of the shape adaptation element preferably maintain their shape to a substantial extent during the transformation from the production to the installation state. In comparison with the shape adaptation section, the connecting sections can thus be rigid.

The seal assembly is preferably a flat material. For the purposes of the present invention, a flat material has an extent in at least one dimension, such as a length, preferably in two dimensions, such as the length and a width, which is many times greater than in another dimension, such as, in particular, a thickness of the flat material.

In particular, the length and the width can define a main plane of extent of the seal assembly.

The shape adaptation section makes it possible to produce the seal assembly in a production state, which has smaller dimensions than the installation state. This allows the use of a smaller injection mold, thereby making it possible to reduce production costs. Moreover, this also enables the use of injection molds with multiple cavities.

In one preferred embodiment, the seal assembly comprises a plurality of shape adaptation elements. For the purposes of the present invention, “a plurality” means two or more. A seal assembly comprising a plurality of shape adaptation elements can be produced in a particularly space-saving production state.

As a preferred option, all the mutually adjacent seal elements are connected to one another via a shape adaptation element of the seal assembly. Accordingly, the seal assembly may also comprise any number of seal elements.

The seal assembly can be an open seal assembly or a closed seal assembly. The seal assembly is preferably a closed seal assembly. An open seal assembly preferably comprises two seal elements at the ends.

The connecting sections of the shape adaptation element are arranged, in particular, at two opposite ends of the shape adaptation section. Via the connecting sections, it is possible to form a positive, nonpositive and/or material connection between the shape adaptation element and the two seal elements.

It may be advantageous if the shape adaptation section is reversibly stretchable and/or reversibly bendable. This can be achieved, in particular, through the selection of a suitable, in particular elastic, material. This has the advantage that the transformation of the seal assembly from the production state to the installation state is more easily possible.

In particular, the shape adaptation section can have a curvature or bend in the production state. For example, the shape adaptation section can be arc-shaped. In order to achieve a particularly nested and/or folded production state, it may be advantageous if the shape adaptation section has a 180° arc shape.

Shape adaptation elements which have such a curved or bent configuration of the shape adaptation section and thus of the shape adaptation element in the production state are, in particular, (reversibly) stretchable.

Alternatively, a shape adaptation element may also have an elongated, in particular linear, configuration in the production state. During the transformation of the seal assembly from the production state to the installation state, the elongated shape adaptation elements can transition to a curved configuration.

The shape adaptation element can be part of an at least substantially linear section in the seal assembly in the installation state.

Alternatively, the shape adaptation element can be part of an angled or bent section in the seal assembly in the installation state.

It is conceivable that the seal assembly exclusively comprises shape adaptation elements which, in the installation state, are part of one or more at least substantially linear sections or part of one or more angled or bent sections. Moreover, the seal assembly can also comprise both configurations of shape adaptation element.

In one preferred embodiment, the shape adaptation section comprises a wave segment, which comprises at least one wave.

Alternatively, the shape adaptation section can consist, in particular substantially, of the wave segment. This means, in particular, that the seal elements are connected to one another exclusively via the wave segment. In other words, the shape adaptation section does not comprise any further segment which connects the two seal elements and/or the two connecting sections to one another. This is not incompatible with the shape adaptation section comprising at least one sealing structure and/or extensions, at least as long as the extensions do not span and/or bridge the at least one wave. Bridging can mean, in particular, that two adjacent wave maxima and/or wave minima are connected to one another.

For the purposes of the present invention, the term “wave” also includes wave-like shapes. These include a zigzag shape or a sawtooth shape. The shape concerned is preferably periodic. As a particular preference, the wave segment has a sinusoidal shape.

The shape adaptation section comprising a wave segment or consisting of the wave segment has the advantage that the seal assembly has less tendency for twisting. This applies especially to wide seal assemblies.

A wide seal assembly is understood to mean a seal assembly, the width of which is greater than its thickness in the main plane of extent. “Thickness” is understood, in particular, to mean an average material thickness. In the case of the average material thickness, recesses and/or projections can be ignored. The width can be, in particular, an average width of the seal elements.

Especially if it is not bridged and/or spanned, the wave segment furthermore has the advantage that the shape adaptation section may be capable of being extended.

If the seal assembly comprises a plurality of shape adaptation elements, the shape adaptation elements can be of identical and/or different design.

All the shape adaptation elements preferably have the same shape. This makes the production of the seal assembly easier.

It may be advantageous if the shape adaptation elements have the same shape but different lengths. As a result, the seal assembly can have substantially any shape in the installation state.

In one preferred embodiment, the wave segment comprises at least three, preferably at least four, particularly preferably at least five, waves. Longer wave segments are distinguished, in particular, by greater flexibility and/or extensibility. The number of waves in a wave segment can be selected, in particular, in accordance with the desired production state, the desired installation state and/or a wavelength of the wave. In one embodiment, a wave segment comprises no more than 25 waves.

It is preferred if the at least three waves have a constant wavelength. In the present case, the wavelength is understood to mean the distance between two adjacent maxima and/or two adjacent minima. A wave segment comprising waves with a constant wavelength has the advantage, in particular, that these are easy to produce and/or have constant properties, in particular stretching and/or bending properties, over the entire length of the wave segment.

Alternatively, the wavelength may also vary within a wave segment. In this way, it is possible, in particular, to adapt the flexibility section by section.

If the seal assembly comprises a plurality of shape adaptation elements, the shape adaptation sections preferably have wave segments which have the same wavelength.

It can be advantageous if a radius of curvature of the at least one wave amounts to at most one fifth of the radius of curvature of the shape adaptation section in the production state and/or in the installation state. The radius of curvature of the at least one wave preferably amounts to at most one tenth of the radius of curvature of the shape adaptation section. In this way, the tension and/or compression forces which occur in the shape adaptation section during bending and/or stretching can be adapted and/or checked.

The seal assembly can have an inner sealing region and/or an outer sealing region. The terms “inner” and “outer” refer to a region surrounded by the seal assembly. In the region of a curvature, the inner sealing region is preferably the sealing region which is situated radially on the inside. In a region of curvature, the outer sealing region is, in particular, the sealing region which is situated radially on the outside.

If a shape adaptation section has a curvature in the production state and is transformed by stretching into the installation state, tension forces and/or extension forces can occur in the radially inner sealing region, and/or compression forces can occur in the radially outer sealing region.

It may be advantageous if the wavelength of the at least one wave is smaller than the radius of curvature of the shape adaptation section in the production state and/or in the installation state. The wavelength preferably amounts to less than one third, particularly preferably less than one quarter, and very particularly preferably less than one fifth, of the radius of curvature of the shape adaptation section.

In one preferred embodiment, the two connecting sections each have at least one fixing structure for fixing the shape adaptation element on a sealing surface. The at least one fixing structure can be a projection or a recess, for example. In the present case, a sealing surface is understood to mean a surface to be sealed. The sealing surface can be the surface of a housing cover and/or of a housing bottom part, for example. The recess can be a depression or an aperture, for example.

The at least one fixing structure can be formed integrally and/or in one piece with the respective connecting section. In principle, the fixing structures can have any desired cross-sectional shape. For example, the cross-sectional shape can have a circular, triangular or quadrilateral shape.

All the fixing structures of the seal assembly are preferably of the same design. Alternatively, the fixing structures can also be of different designs. For example, one connecting section can have a projection as a fixing structure, and the connecting section adjacent to the abovementioned connecting section can have a recess.

In one preferred embodiment, each connecting section of the seal assembly can have precisely one fixing structure.

The fixing structures have the advantage that the positioning of the seal assembly on the sealing surface can be fixed. In particular, the fixing structures can be brought into engagement with corresponding mating fixing structures on the sealing surface. In this way, the shape adaptation element can be fixed under tension on the sealing surface. Twisting in the installation state is thereby prevented in an optimum manner.

In one preferred embodiment, the two connecting sections and/or the shape adaptation section comprise/comprises an elastomer material. In addition or as an alternative, the two connecting sections and/or the shape adaptation section can consist, in particular substantially, of the elastomer material. The use of an elastomer material has the advantage that the two connecting sections and/or the shape adaptation section are/is flexible and/or elastic. In particular, the shape adaptation section can be reversibly stretchable and/or reversibly bendable. In other words, the shape adaptation section can function like a hinge section.

The elastomer material is preferably a fluororubber (FKM), an ethylene-propylene-diene rubber (EPDM), an acrylate-ethylene rubber (AEM), an acrylate rubber (ACM), a (hydrogenated) acrylonitrile-butadiene rubber (HNBR, NBR), a silicone rubber (VMQ), such as a fluoro-silicone rubber (FVMQ) or a mixture of the abovementioned elastomers.

The abovementioned elastomers are suitable, in particular, for use in electrochemical systems. In addition, the connecting sections and/or the shape adaptation section can undergo primary forming. This means that the two connecting sections and/or the shape adaptation section can be produced by press forming, injection molding, extrusion and/or deep drawing, for example.

It is conceivable that the elastomer material comprises further constituents, e.g. pigments, flame retardants and/or antistatic additives. In particular, the further constituents enable adaptation of the properties of the elastomer material to the respective application.

The elastomer material preferably consists substantially of one of the abovementioned elastomers or a mixture thereof. This means that the elastomer material can comprise further constituents, but these influence the advantageous material properties only insignificantly or not at all.

It is preferred if the two connecting sections and the shape adaptation section comprise the same elastomer material or consist of the same elastomer material. In this way, the shape adaptation element can be produced in a single production step. Moreover, the two connecting sections and the shape adaptation section can be formed integrally and in one piece.

In one preferred embodiment, the shape adaptation element is a flat material. This means, in particular, that the two connecting sections and the shape adaptation section lie in the main plane of extent of the seal assembly. Accordingly, the at least one wave of the wave segment can likewise lie in the main plane of extent of the seal assembly. Such an embodiment has the advantage that the seal assembly can be configured entirely as a flat gasket. In particular, the seal assembly can be used as a flange seal.

It may be advantageous if the seal elements consist of a metal and/or a polymer material. Alternatively, the seal elements may comprise the metal and/or the polymer material.

In particular, the metal can be aluminum, copper, silver, nickel or an alloy of the abovementioned metals.

In particular, the polymer material can be an elastomer material described herein.

In particular, the choice of the material of the seal elements can be adapted to the intended use of the seal assembly.

In one preferred embodiment, the seal elements consist of a metal-polymer composite material.

As a particular preference, the seal elements comprise a metal support, which is connected to the polymer material on at least one side face, preferably two side faces, in particular mutually opposite side faces. A side face is understood to mean a surface which delimits the metal support in the main plane of extent. The at least one side face is preferably perpendicular to the main plane of extent. Such an embodiment has the advantage that an upper and a lower surface of the metal support are exposed in and/or parallel to the main plane of extent and are available to form an electrically conductive connection.

It may be particularly advantageous if the polymer material of the seal elements and the elastomer material of the two connecting sections and/or the shape adaptation section are the same materials.

It may be advantageous if the seal elements and the shape adaptation element are of one-piece and/or integral design. This allows simple production and/or leads to a seal assembly with a high stability. For the purposes of the present invention, “integral” means that it is not possible to separate the interconnected elements in a nondestructive way. A one-piece seal assembly is also always of integral design.

The seal elements and the shape adaptation element can be connected to one another materially, positively and/or nonpositively. The connection is preferably a material connection. The formation of a material connection can take place, in particular, in an injection molding process. The process conditions depend on the primary polymer material used and/or on the elastomer material used.

In one preferred embodiment, the seal elements and the shape adaptation element have a sealing structure, in particular a continuous sealing structure. The seal elements and the shape adaptation element can also have a plurality of sealing structures, in particular continuous sealing structures. It is thereby possible to improve the sealing properties of the seal assembly.

It is particularly preferred if the entire seal assembly has at least one continuous sealing structure.

In one embodiment, the sealing structure is arranged on a first surface of the seal elements, the shape adaptation element and/or the entire seal assembly which faces the sealing surface.

Alternatively, a second sealing structure can be formed on a second surface of the seal elements, the shape adaptation element and/or the entire seal assembly which faces away from the first surface.

It is particularly preferred if the sealing structure is designed as part of the seal elements, the shape adaptation element and/or the entire seal assembly. This gives a seal assembly which has a seal profile, at least in some section or sections. The entire seal assembly preferably has a continuous seal profile. The sealing structure can be designed as a bead, rib or local thickening, for example.

The continuous sealing structure can consist of a single material. Alternatively, it is conceivable that the continuous sealing structure consists of different materials, at least in some section or sections. The material of the sealing structure is preferably the same material as the polymer material of the seal elements and/or the elastomer material of the connecting sections and/or of the shape adaptation section. This has the advantage that the sealing structure can be formed in one piece with the seal elements, the shape adaptation element and/or the entire seal assembly.

It may be advantageous if the seal elements and the shape adaptation section of the shape adaptation element have a different width in the main plane of extent of the seal assembly. The width of the shape adaptation section is preferably less than the width of the seal elements. The different widths have the advantage that the seal assembly has a higher flexibility.

In particular, the widths can be average widths. Local recesses and/or projections, such as protuberances or extensions can be left out of account in the average width.

In one preferred embodiment, the connecting sections of the shape adaptation element each form a transitional region between the seal elements and the shape adaptation section. In particular, the connecting sections can have a shape which tapers towards the shape adaptation section, thus ensuring a continuous transition from the width of the seal elements to the width of the shape adaptation section.

It is conceivable that the seal elements, in particular the polymer material of the seal element, and the shape adaptation element have the same thickness. The thickness is understood to mean, in particular, the average material thickness perpendicular to the main plane of extent of the seal assembly. Optionally present apertures and/or projections can be left out of account in determining the average material thickness.

In particular, the thickness of the seal assembly can be selected in accordance with the intended use.

In embodiments in which the seal elements comprise a metal support, as described above, the metal support and the polymer material connected to the metal support can have different thicknesses from one another.

The thickness of the polymer material preferably amounts to at least 110%, preferably at least 120%, particularly preferably at least 130%, very particularly preferably 150%, of the thickness of the metal support.

The thickness of the polymer material preferably amounts to at most 200%, preferably at most 180%, particularly preferably at most 170%, of the thickness of the metal support.

For example, the thickness of the polymer material can amount to 110 to 200%, preferably 120 to 180%, particularly preferably 130% to 170%, of the thickness of the metal support.

This has the advantage that the seal assembly can be compressed in the installed state in order to maximize the effect of the seal. During compression, the polymer material is, in particular, compressed to the thickness of the metal support.

If the thickness of the metal support is 2.5 mm and the thickness of the polymer material is 3.75 mm (=150%), the seal can be compressed to 2.5 mm, this corresponding to a compression of the polymer material of 33%.

The thickness of the metal support, of the polymer material and/or of the shape adaptation element is preferably constant. A constant thickness has the advantage that a uniform sealing effect can be achieved.

The object according to the invention is furthermore achieved by a housing according to the independent claim relating thereto.

The housing can be a housing for an electrochemical system, for example. The electrochemical system is preferably a battery system or a fuel cell system.

The housing can comprise two mutually opposite sealing surfaces and a seal assembly arranged between the sealing surfaces. In particular, the seal assembly can be any seal assembly described herein.

The use of the seal assembly according to the invention has the advantage that the seal assembly has at most a slight tendency for twisting in the installation state. Moreover, the use of the seal assembly makes it possible to compensate for length changes that occur on account of batch-related shrinkage differences or tolerances on the sealing surfaces. Very large length changes can occur, for example, in the case of seal assemblies of large dimensions, even in the case of small batch-and/or process-induced shrinkage differences of 0.2%.

In one preferred embodiment, one of the two mutually opposite sealing surfaces is formed by the surface of a housing bottom part. The second sealing surface, which lies opposite the first sealing surface, is preferably formed by a housing cover.

In principle, the housing can have any desired shape. For example, the housing can have a trough-shaped or tray-shaped or cuboidal housing bottom part. In particular, the housing cover can be dimensioned in such a way that the sealing surface of the housing cover and the sealing surface of the housing bottom part form a flange joint. In such an embodiment, the seal assembly can form a flange joint.

It is preferred if none of the sealing surfaces has a groove, in particular a continuous groove to receive the seal assembly. In this way, it is possible to eliminate the process step of milling a groove.

The housing and the components thereof, such as the housing cover and the housing bottom part, can comprise a metal and/or a plastics material or consist of the metal and/or the plastics material. Electrically conductive materials are preferably used. The use of electrically conductive materials has the advantage that the electromagnetic compatibility can be enhanced.

Aluminum or a steel is preferably used as a metal.

Electrically conductive plastics materials are preferably used as a plastics material. In particular, these can comprise conventional conductive additives.

The housing and/or the components thereof comprising the plastics material can have at least one electrically conductive insert, in particular a metal insert, for contact making. The at least one insert can enable the use of non-conductive plastics materials. It is also conceivable for the electrically conductive plastics materials to be used in combination with the at least one insert.

Before and/or during the installation of the seal assembly, the seal assembly can be transformed from its production state to the installation state. This is accomplished, in particular, by stretching or bending the one or more shaped adaptation sections. In particular, the sealing elements can retain their shape. In particular, the sealing elements can form rigid elements of the seal assembly.

The sealing elements of the seal assembly correspond section by section in their shape to the profile of the sealing surfaces. The one or more adaptation elements of the seal assembly, on the other hand, can be adapted to the profile of the sealing surfaces by bending or stretching. The profile of the sealing surfaces can be straight, angled and/or rounded section by section.

The number of shape adaptation elements and sealing elements of the seal assembly is preferably chosen so that the seal assembly can be produced in an injection mold which is as small as possible but, at the same time, has adequate stability by virtue of having as many sealing elements as possible.

In one preferred embodiment, the housing comprises fixing means for fixing the housing cover and/or the seal assembly on the housing bottom part. Suitable fixing means can be screws and/or latching elements, for example. In this way, it is possible, after the installation of the seal assembly, to produce a nonpositive and/or positive connection between the housing cover and the housing bottom part, ensuring that the housing is closed.

The housing can comprise further housing components. For example, the housing bottom part can be of multi-part design. The same can apply to the housing cover.

In one preferred embodiment, the housing comprises two or more seal assemblies. Depending on the respective sealing surfaces to be sealed, the two or more seal assemblies can be of the same or different design.

It may be advantageous if one of the two sealing surfaces has mutually spaced mating fixing structures in a main plane extent of the seal assembly, which structures can be brought into engagement with fixing structures of the shape adaptation element of the seal assembly. This has the advantage that the seal assembly is fixed on at least one sealing surface in the region of the flexible shape adaptation elements.

In particular, the mating fixing structures can have a shape complementary to the fixing structures of the shape adaptation element, at least in some section or sections. It may be advantageous if the mating fixing structures are fully complementary with the fixing structures.

The mating fixing structures can accordingly be configured as projections and/or apertures.

In addition or as an alternative, the mutually opposite sealing surfaces can each have at least one of the mutually spaced mating fixing structures. In such an embodiment, the shape adaptation element comprises fixing structures which are arranged and/or formed on surfaces of the shape adaptation element, in particular of the connecting sections, which face away from one another.

It may be advantageous if the seal elements have additional fixing structures. These can be brought into engagement with corresponding mating fixing structures on one and/or both sealing surfaces.

In one preferred embodiment, a distance between the mating fixing structures of the sealing surface or of the sealing surfaces is greater than a distance between the fixing structures of the shape adaptation element. If the mating fixing structures and the fixing structures are brought into engagement, a tensile stress acts, in particular, on the shape adaptation section of the shape adaptation element. This tensile stress leads to a further reduction in the tendency of the seal assembly to twist.

The invention furthermore relates to a method for producing a seal assembly.

The seal assembly can be, in particular, any seal assembly described herein.

The method comprises at least the following step:
i) injecting an elastomer material into an injection mold, such that a shape adaptation element of the seal assembly is formed in a production state.

In particular, the elastomer material can be any elastomer material described herein.

The injection mold is preferably a component of a conventional injection molding apparatus. The injection molding apparatus can be, in particular, an injection unit comprising a plasticizing screw, which is arranged in a plasticizing cylinder. The temperature of the plasticizing cylinder can be controlled from the outside by means of electric heating bands.

The elastomer material can be introduced into an initial section of the plasticizing cylinder. The elastomer material is conveyed through the plasticizing cylinder by a movement of the plasticizing screw, wherein the elastomer material melts on account of shearing forces and/or externally applied heat. At an opposite end of the plasticizing cylinder from the initial section there is a nozzle, which forms a transition to an injection mold.

The injection mold of the injection molding apparatus comprises, in particular, two mold halves, which in a closed state form a cavity which can define the shape of the seal assembly in the production state.

It is conceivable that the entire seal assembly, that is to say, in particular, the two or more seal elements and the at least one shape adaptation element, via which the two or more seal elements are connected to one another, is formed in step i). In such an embodiment, it is possible to form a one-piece and integral seal assembly which consists entirely of the elastomer material.

Alternatively, it is conceivable that the at least one of the two or more seal elements and/or at least one seal element part are/is placed in the injection mold before the injection of the elastomer material.

In particular, the at least one seal element and/or the at least one seal element part can consist of a metal and/or a polymer material.

The at least one seal element and/or the at least one seal element part can, in particular, be produced in an upstream stamping and/or injection molding process.

If at least one of the two or more seal elements and/or the at least one seal element part are/is placed in the injection mold, then in step i) a material and/or positive connection can be formed between the shape adaptation element and the at least one seal element and/or the at least one seal element part.

The at least one seal element and/or at least one seal element part can be at least partially overmolded, and/or material injected through it/them, to form the positive connection. A material connection can be formed, in particular, if an adhesion promoter is applied to the at least one seal element and/or at least one seal element part, and/or the at least one seal element and/or the at least one seal element part comprises the polymer material or consists of such a polymer material.

In step i), a finished seal element of the seal assembly can be formed by injecting material at least partially around and/or through it.

The process conditions of injection molding can be chosen, in particular, in accordance with the materials used, the shape and the dimensioning of the seal assembly and are known to a person skilled in the art.

The production of the seal assembly in the production state has the advantage that it is possible to use a mold of smaller dimensions than would be necessary if producing the seal assembly in the installation state.

Of course, features described in connection with an article according to the invention can also form features of some other article according to the invention described herein. Here, articles according to the invention are, in particular, the seal assembly, the housing comprising the seal assembly, and the method for producing the seal assembly.

Further preferred features and/or advantages of the invention form the subject matter of the following description and of the graphical illustration of exemplary embodiments.

### BRIEF DESCRIPTION OF THE DRAWINGS:

FIG. 1: shows a schematic plan view of a seal assembly according to a first embodiment of the invention in a production state;

FIG. 2: shows a schematic plan view of a seal assembly according to a second embodiment of the invention in an installation state;

FIG. 3: shows a schematic detail view of a shape adaptation element of a seal assembly according to one embodiment of the invention;

FIG. 4: shows a schematic view of the underside of the shape adaptation element from FIG. 3 in a stretched state;

FIG. 5: shows a schematic detail view of another shape adaptation element of a seal assembly according to one embodiment of the invention;

FIG. 6: shows a cross section of a connecting section of the shape adaptation element from FIG. 3 along the line A-A;

FIG. 7: shows a cross section of a shape adaptation section of the shape adaptation element from FIG. 5 along the line B-B; and

FIG. 8: shows a segment of a housing comprising a seal assembly according to one embodiment of the invention.

In all the figures, elements that are identical or functionally equivalent are provided with the same reference signs.

### DETAILED DESCRIPTION OF THE DRAWINGS

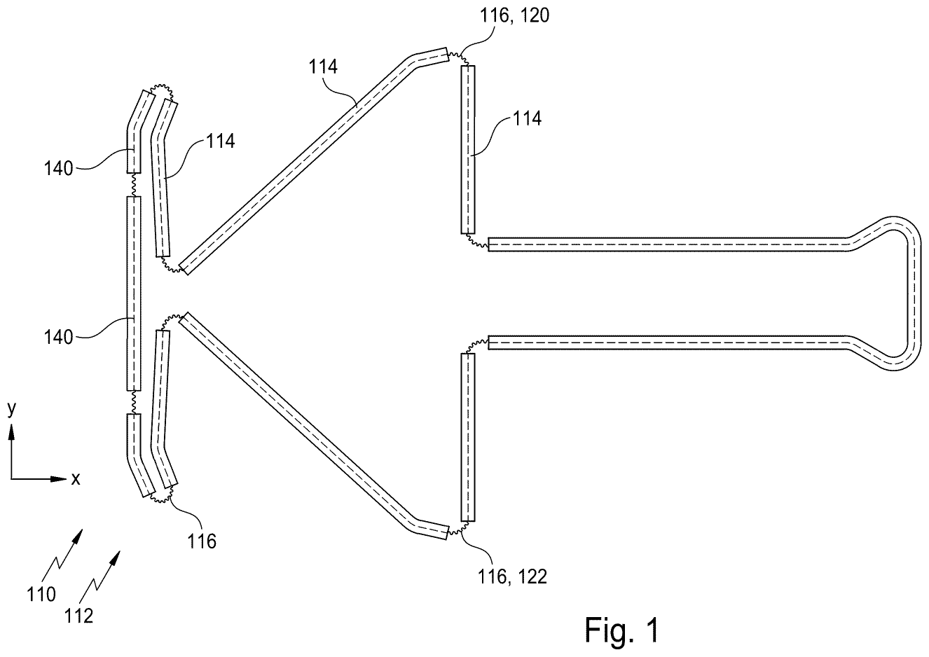

A seal assembly 110 according to one embodiment of the invention is visible in FIG. 1. The seal assembly 110 is shown in its main plane of extent, which in the present case is the x, y plane. The seal assembly 110 can be, in particular, a flat gasket 112. In particular, the flat gasket 112 can form a flange seal.

The seal assembly 110 comprises a multiplicity of seal elements 114. Mutually adjacent seal elements 114 are each connected via a shape adaptation element 116. The shape adaptation elements 116 are illustrated only schematically by wavy lines in FIG. 1.

The shape adaptation elements 116 of the seal assembly 110 each comprise a shape adaptation section 120. In the present case, the shape adaptation section 120 consists of a wave segment 122. The wave segment 122 comprises at least one wave 124 (not shown specifically).

In the present case, the seal assembly 110 is illustrated in its production state. In the production state, the seal assembly 110 can be, in particular, nested and/or folded up. This has the significant advantage that the seal assembly 110 can be produced in a relatively small injection mold.

The production of the seal assembly 110 in the production state is made possible, in particular, by the multiplicity of shape adaptation elements 116. By virtue of the shape adaptation section 120, the shape adaptation elements 116 are stretchable and/or bendable. In the production state, stretchable shape adaptation elements 116 are, in particular, in curved or bent form (curved or bent configuration). A shape adaptation element 116 can define a 180° arc, for example.

Alternatively, a shape adaptation element 116 can also have a stretched, in particular linear, configuration in the production state. During the transformation of the seal assembly 110 from the production state to an installation state, the stretched shape adaptation elements 116 can transition to a curved configuration.

In contrast, the seal elements 114 of the seal assembly 110 retain their shape, at least very largely, preferably completely. In other words, the seal elements 114 are rigid elements of the seal assembly 110.

In the present case, the seal assembly 110 is a closed seal assembly 110. In the present case, an area enclosed by the seal assembly 110 is referred to as internal. In corresponding fashion, a side delimiting the internal area can be referred to as an inner side of the seal assembly 110. A side facing away from the inner side can be referred to as an outer side of the seal assembly 110.

Also visible is a sealing structure 140. In the present case, the sealing structure 140 is illustrated as a dashed line. In embodiments in which the shape adaptation elements 116 also include the sealing structure 140, the seal assembly 110 has a continuous sealing structure 140. In the illustrated closed form of the seal assembly 110, the sealing structure 140 is accordingly an encircling sealing structure 140 (encircling the internal area). As illustrated, the sealing structure 140 can extend centrally on the seal elements 114 and the shape adaptation elements 116 (not shown).

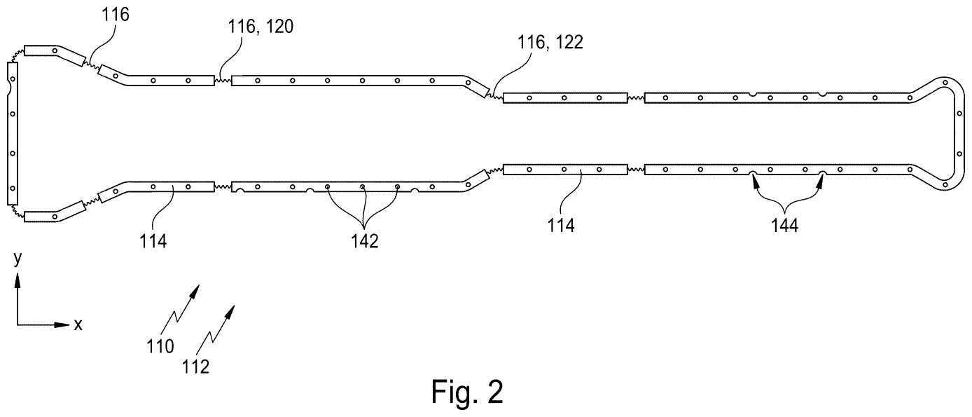

FIG. 2 illustrates a seal assembly 110, which, in particular, can be a flat gasket 112. In contrast to the embodiment illustrated in FIG. 1, the seal assembly 110 illustrated in FIG. 2 is in the installation state. It is clearly apparent that the seal assembly 110 has a significantly greater longitudinal extent (in the x direction) than the seal assembly 110 in the production state. Without shape adaptation elements 116, a correspondingly large injection mold would be required to produce the seal assembly 110 shown.

It is apparent that shape adaptation sections 120 which have a bent configuration in the production state are at least partially or completely extended in the installation state. The situation may be reversed in the case of shape adaptation sections 120 which have a substantially linear configuration in the production state. These can have a bent configuration in the installation state.

In particular, the shape adaptation elements 116 can consist of or comprise an elastomer material mentioned herein. In particular, this enables repeated return from the installation state to the production state and vice versa. In other words, the shape adaptation elements 116 can perform reversible stretching and bending movements, like a hinge element.

To facilitate the installation of the seal assembly 110, the seal assembly 110, in particular the seal elements 114 thereof, can comprise a multiplicity of apertures 142 and/or recesses 144. These can be brought into engagement with mating fixing structures 134 of complementary design, e.g. projections 136 (not shown).

A comparison with the embodiment illustrated in FIG. 1 shows that the shape of the seal elements 114 remains substantially unchanged during the transformation from the production state to the installation state (and vice versa).

In other respects, the embodiment of the seal assembly 110 which is illustrated in FIG. 2 coincides in respect of structure and functioning with the embodiment illustrated in FIG. 1, and therefore to this extent reference is made to the above description thereof.

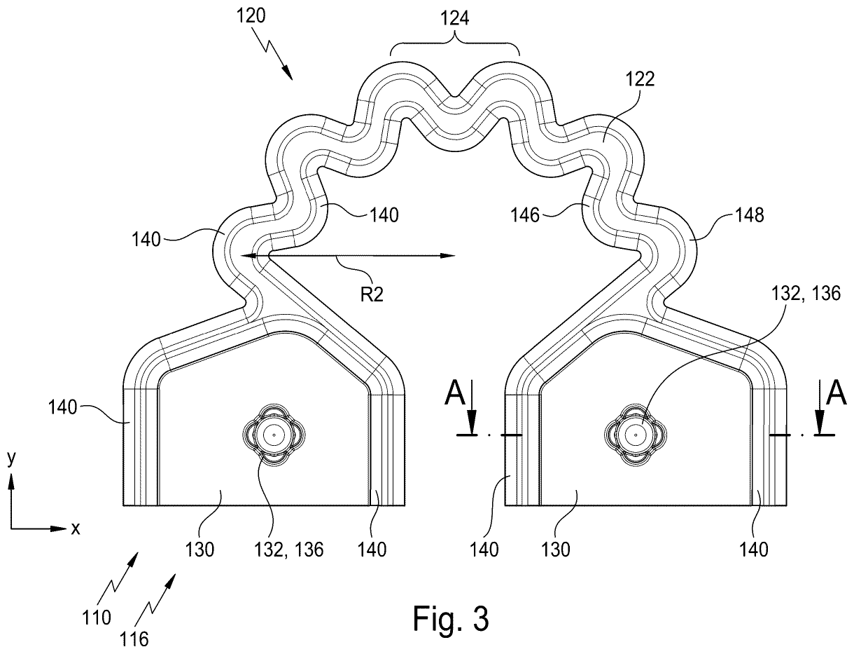

FIG. 3 illustrates a plan view of a shape adaptation element 116 for a seal assembly 110 in the main plane of extent of the seal assembly 110. In particular, the seal assembly 110 can be the seal assemblies 110 illustrated in FIG. 1 and/or FIG. 2.

The shape adaptation element 116 comprises a shape adaptation section 120, the ends of which are each connected to a connecting section 130. In the present case, the connecting sections 130 and the shape adaptation section 120 are of one-piece design.

It is clearly apparent that in the present case the shape adaptation section 120 consists of a wave segment 122 which comprises a plurality of waves 124. Consequently, the connecting sections 130 of the shape adaptation element 116 are connected to one another only via the wave segment 122. In particular, the waves 124 are not additionally bridged with one another since this would be detrimental to the advantageous low tendency for twisting.

In the present case, the shape adaptation element 116 is illustrated in a bent configuration, in particular in the form of a 180°arc. Such a configuration can be present, for example, in the production state in the seal assembly 110 illustrated in FIG. 1. Accordingly, the radially inner side in the region of the arc-shaped wave segment 122 is the inner side of the shape adaptation element 116 and of the seal assembly 110. A side facing away from the inner side is accordingly the outer side.

The radius of curvature R2 can be used as a measure of the degree of curvature of the wave segment 122. This preferably extends from an imaginary central point to the center of the wave segment 122.

For better sealing, the shape adaptation element 116 has sealing structures 140. In the present case, these are an inner sealing structure 146 and an outer sealing structure 148. The sealing structures 146 and 148 are also formed in the region of the connecting sections 130, and therefore continuous sealing structures 140 are formed.

The connecting sections 130 serve as a transitional region, in which adaptation of the width takes place. This enables the formation of a continuous sealing structure 140, in particular a sealing structure which fully encircles the seal assembly 110.

The connecting sections 130 furthermore each have a fixing structure 132. In the present case, the fixing structure 132 is in the form of a projection 136. To form a stable, in particular positive, connection of the seal assembly 110 to sealing surfaces 108 (not illustrated) in the region of the shape adaptation element 116, the projections 136, for their part, have four projections, thus preventing twisting of the shape adaptation element 116 relative to the sealing surface 108 in the installed state.

All the shape adaptation elements 116 of the seal assembly 110 are preferably of the same design in respect of shape and/or material. There can be differences, in particular, in the number of waves 124.

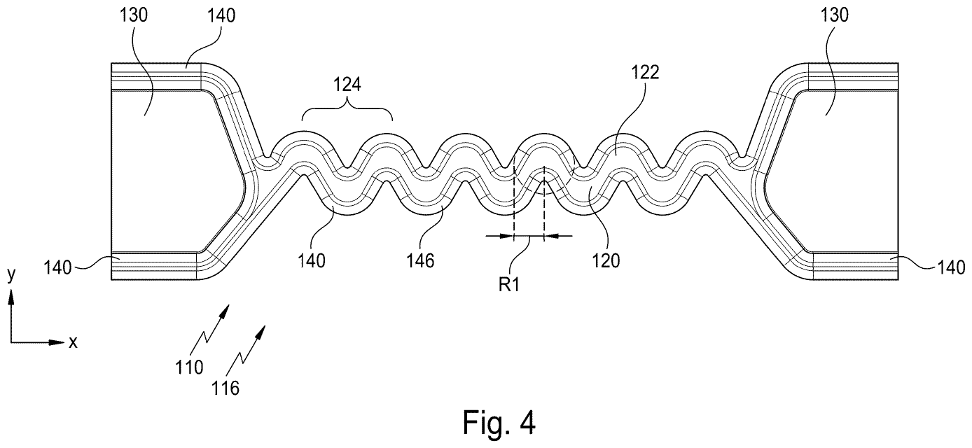

FIG. 4 illustrates a bottom view of the shape adaptation element 116 from FIG. 3. The shape adaptation element 116 is now in a stretched configuration. The stretching can take place, for example, in the context of installation of the seal assembly 110 (transition from the production state to the installation state).

Owing to the stretching, a tensile stress acts on the inner sealing structure 146. In contrast, the outer sealing structure 148 situated opposite the inner sealing structure 146 is compressed. By virtue of the wave segment 122, in the present case comprising five waves 124, twisting is efficiently prevented, even in the case of particularly wide seal assemblies 110.

This effect may be particularly clearly pronounced if a radius of curvature R1 of the waves 124 is smaller than the radius of curvature R2 of the wave segment 122 in the bent configuration (see FIG. 3). In the present case, the ratio of R1 to R2 is approximately 1/7.

It is clearly apparent that the underside of the shape adaptation element 116 does not have a fixing structure 132. It is conceivable that one of the connecting sections 130 has the fixing structure 132 on the upper side of the shape adaptation element 116, and the other connecting section 130 has the fixing structure 132 on the underside facing away from the upper side. It is likewise conceivable that both connecting sections 130 have fixing structures 132 both on the upper side and on the underside. This enables the seal assembly 110 to be fixed on the sealing surface 108 of a housing cover 106 (not illustrated) and/or on the sealing surface 108 of a housing bottom part 104 (not illustrated).

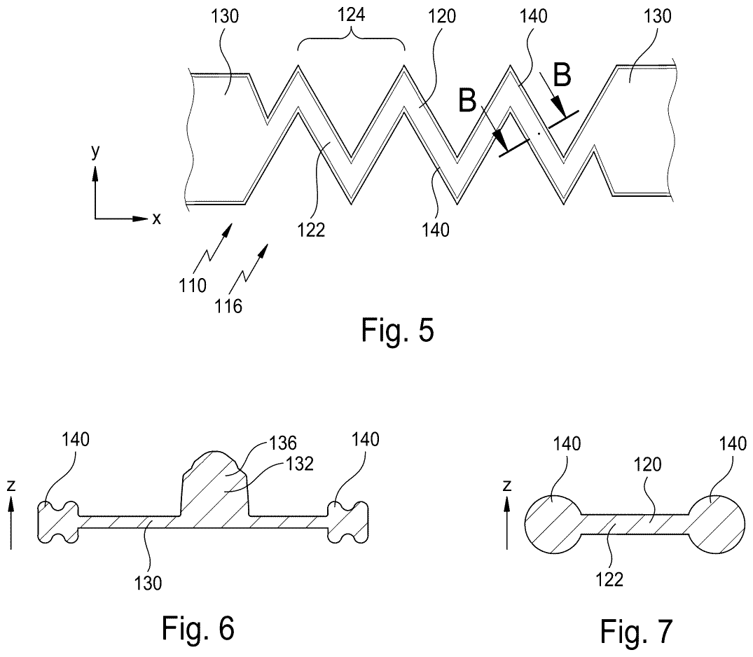

FIG. 5 shows a shape adaptation element 116 for a seal assembly 110 according to another embodiment of the invention. The shape adaptation element 116 comprises two connecting sections 130, which are connected to one another via a shape adaptation section 120.

In the present case, the shape adaptation section 120 consists of a wave segment 122. In contrast to the embodiment illustrated in FIG. 3 and FIG. 4, the wave segment 122 comprises waves 124 with a zigzag shape. The zigzag shape illustrated also leads to efficient reduction of twisting of the seal assembly 110 in the installation state.

It is also clearly apparent that the amplitude of the waves 124 is significantly greater than the amplitude of the waves 124 in FIG. 3 and FIG. 4. As a result, the extent of the shape adaptation element 116 in the y direction can correspond substantially to the width of the connecting sections 130. The extent of the shape adaptation section 120 in the y direction is preferably less than or equal to the width of the connecting sections 130. The width of the connecting sections 130 preferably corresponds to the width of seal elements 114 (not illustrated) of the seal assembly 110.

The shape adaptation element 116 furthermore has two sealing structures 140, which are configured as continuous sealing structures 140, at least in the region of the shape adaptation element 116.

FIG. 6 illustrates a cross section of the connecting section 130 of the shape adaptation element 116 from FIG. 3 along the line A-A.

It is clearly apparent that the thickness in the z direction is significantly less than the width of the connecting section 130, wherein the fixing structure 132, which is designed as a projection 136, can be left out of account from the thickness.

As is apparent especially in FIG. 3 and FIG. 4, the connecting sections 130 have a further sealing structure in addition to the inner sealing structure 146 and to the outer sealing structure 148, with the result that the H-shaped seal profile illustrated in FIG. 6 is formed.

In principle, the seal assembly 110 can have sealing structures 140 of any configuration, and therefore different seal profiles may be present.

Such an alternative seal profile is illustrated in FIG. 7. FIG. 7 shows a cross section of the shape adaptation section 120 of the shape adaptation element 116 from FIG. 5 along the line B-B. It is clearly apparent that the sealing structures 140 lead to a substantially round cross section, at least in some section or sections.

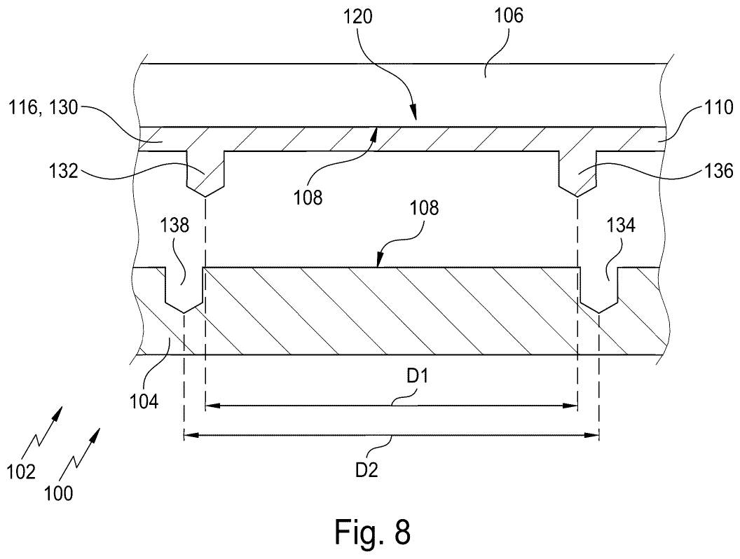

FIG. 8 illustrates a detail view of a housing 100 in the region of a seal assembly 110. The housing 100 can be, in particular, a housing 100 for an electrochemical system 102 (not illustrated). In particular, the electrochemical system 102 can be a battery system.

The housing 100 comprises a housing bottom part 104 having a sealing surface 108. The housing 100 furthermore comprises a housing cover 106 having a sealing surface 108 facing the sealing surface 108 of the housing bottom part 104. The seal assembly 110 is situated between the sealing surfaces 108.

The figure shows a segment of the seal assembly 110 in the region of a shape adaptation element 116 of the seal assembly 110. The shape adaptation element 116 comprises two connecting sections 130, which are connected to one another via a shape adaptation section 120. For the sake of simplicity, waves 124 of a wave segment 122 of the shape adaptation section 120 are not illustrated.

Each of the connecting sections 130 comprises a fixing structure 132, which in the present case is designed as a projection 136. The housing bottom part 104 of the housing 100 has two mating fixing structures 134, which are designed as recesses 138. The shape of the recesses 138 is complementary to the shape of the projections 136 of the connecting sections 130 of the seal assembly 110.

It is clearly apparent that a distance D1 between the projections 136 is less than a distance D2 between the recesses 138. If the fixing structures 132 are brought into engagement with the mating fixing structures 134 during assembly, a tensile stress acts on the shape adaptation section 120. As a result, the waves 124 of the wave segment 122 (not illustrated) are extended. The tensile stress has the advantage that a tendency of the seal assembly 110 to twist is further reduced. Moreover, the extensibility of the shape adaptation section 120 on account of the wave segment 122 enables any length deviations due to production tolerances to be compensated. It is thereby possible to achieve a particularly high level of leaktightness of the assembled housing 100.

### LIST OF REFERENCE SIGNS

100 housing
102 electrochemical system
104 housing bottom part
106 housing cover
108 sealing surface
110 seal assembly
112 flat gasket
114 seal element
116 shape adaptation element
120 shape adaptation section
122 wave segment
124 wave
130 connecting section
132 fixing structure
134 mating fixing structure
136 projection
138 recess
140 sealing structure
142 aperture
144 recess
146 inner sealing structure
148 outer sealing structure
R1 radius of curvature
R2 radius of curvature
D1
D2 distance

1. A seal assembly comprising:
two seal elements, wherein
said two seal elements are connected to one another via a shape adaptation element,
the shape adaptation element includes a shape adaptation section and two connecting sections for connecting the shape adaptation element to the two seal elements of the seal assembly, and
the shape adaptation section is capable of being transformed from a production state to an installation state by stretching, or by reversible stretching, or by bending, or by reversible bending.

2. The seal assembly as claimed in claim 1, wherein the shape adaptation section includes a wave segment, wherein
the wave segment includes at least one wave.

3. The seal assembly as claimed in claim 2, wherein
the wave segment includes at least three waves, or at least four waves, or at least five waves.

4. The seal assembly as claimed in claim 3, wherein
the at least three waves, or the at least four waves, or the at least five waves have a constant wavelength.

5. The seal assembly as claimed in claim 2, wherein
a radius of curvature of the at least one wave amounts to at most one fifth or at most one tenth of a radius of curvature of the shape adaptation section in the production state and/or in the installation state.

6. The seal assembly as claimed in claim 1, wherein
the two connecting sections each have a fixing structure or a projection or a recess for fixing the shape adaptation element on a sealing surface.

7. The seal assembly as claimed in claim 1, wherein
the two connecting sections and/or the shape adaptation section includes an elastomer material or consist of the elastomer material.

8. The seal assembly as claimed in claim 7, wherein
the elastomer material is a fluororubber, an ethylene-propylene-diene rubber, an acrylate-ethylene rubber, an acrylate rubber, an acrylonitrile-butadiene rubber, a silicone rubber, or a mixture of the abovementioned elastomers.

9. The seal assembly as claimed in claim 1, wherein
the shape adaptation element is a flat material.

10. The seal assembly as claimed in claim 1, wherein
the seal elements consist of a metal and/or a polymer material or comprise the metal and/or the polymer material.

11. The seal assembly as claimed in claim 1, wherein
the seal elements and the shape adaptation element are of one-piece and/or integral design.

12. The seal assembly as claimed in claim 1, wherein
the seal elements and the shape adaptation element have a continuous sealing structure.

13. The seal assembly as claimed in claim 1, wherein
the seal elements and the shape adaptation element have a different width in a main plane of extent.

14. The seal assembly as claimed in claim 1, wherein
the seal elements and the shape adaptation element have the same thickness.

15. The seal assembly as claimed in claim 1, wherein
the seal assembly is a flat gasket for a housing for an electrochemical system.

16. A housing comprising:
two mutually opposite sealing surfaces and said seal assembly as claimed in claim 1 arranged between the two mutually opposite sealing surfaces.

17. The housing as claimed in claim 16, wherein
one of the two mutually opposite sealing surfaces has mutually spaced mating fixing structures in a main plane of extent of the seal assembly, which mating fixing structures can be brought into engagement with fixing structures of the shape adaptation element.

18. The housing as claimed in claim 17, wherein
a distance between the mating fixing structures is greater than a distance between the fixing structures.

19. The housing as claimed in claim 16, wherein
the housing is a housing for an electrochemical system.

20. A method for producing said seal assembly as claimed in claim 1, wherein the method comprises at least the following:
i) injecting an elastomer material into an injection mold, whereby a shape adaptation element of the seal assembly is formed in a production state.

21. The method as claimed in claim 20, wherein
at least one seal element consisting of a metal and/or a polymer material, and/or at least one seal element part consisting of a metal and/or a polymer material are/is placed in the injection mold before injection, with the result that, in i), a material and/or positive connection is formed between the shape adaptation element and the at least one seal element and/or the at least one seal element part.
